(19) United States
(12) Patent Application Publication
(10) Pub. No.: US 2011/0313996 A1
(43) Pub. Date: Dec. 22, 2011

(54) CAMPAIGN TRACKING PLATFORM FOR SOCIAL MEDIA MARKETING

(75) Inventors: Jonathan H. Strauss, Beverly Hills, CA (US); Corey W. Reece, San Francisco, CA (US); Michael B. Orr, Oviedo, FL (US)

(73) Assignee: SNOWBALL FACTORY, INC. A Delaware Corporation

(21) Appl. No.: 13/101,138

(22) Filed: May 4, 2011

Related U.S. Application Data
(60) Provisional application No. 61/331,380, filed on May 4, 2010.

(51) Int. Cl. G06F 17/30

(52) U.S. Cl. 707/709; 707/E17.108

(57) ABSTRACT

Methods and systems for facilitating a campaign tracking platform for social media marketing are provided. According to one embodiment, a method for collecting click information regarding tracking links is provided. A tracking link is generated corresponding to a target source of content through which a subscriber of the social media campaign tracking platform can share the content with third parties via social media. The tracking link has encoded therein structured metadata indicative of a social media action within which the tracking link is contained. Responsive to receiving a click-through event for the tracking link from a requestor, click information is stored in a consumption database associated with the social media campaign tracking platform and the requestor is redirected to the target source.

### CROSS-REFERENCE TO RELATED APPLICATIONS

This application claims the benefit of priority to U.S. Provisional Patent Application No. 61/331,380, filed on May 4, 2011, the contents of which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2010-2011, Snowball Factory, Inc.

### BACKGROUND

1. Field

Embodiments of the present invention generally relate to the field of online advertising and associated public relations and marketing tools. In particular, embodiments of the present invention relate to tools for professional marketers and publishers to use and track social media marketing efforts.

2. Description of the Related Art

In the last several years, the meteoric rise in the popularity of social media services and participatory content publishing services, such as Blogger, Flickr, YouTube, MySpace, Facebook and Twitter, has made this medium an essential marketing medium. In December of 2009, YouTube, Facebook and Twitter combined to have over 246 million unique visitors in the US alone according to Compete.com

Content is typically the product best marketed through social media because it is most likely to benefit from the viral dynamics of word of mouth. Major movie studios spent over $16 billion on advertising globally in 2009. While only 7.7% of their US spend was online in 2009, that is expected to nearly double to 14.2% in 2013.

Despite the imminent influx of money, the social media marketing space is highly immature and doesn't yet provide the kinds of tools and services professional marketers have come to expect from other marketing channels. This issue is exacerbated by the fact that social media is first and foremost a consumer medium that has been appropriated by marketers, but was not originally designed with their needs in mind. As such, marketers have resigned themselves to using social media without some of the most basic tools of their trade, like return on investment (ROI) measurement.

In view of the foregoing, it is desirable to make social media a more efficient, effective and measurable marketing channel.

### SUMMARY

Methods and systems are described for facilitating a campaign tracking platform for social media marketing. According to one embodiment, a method for collecting click information regarding tracking links is provided. A tracking link is generated corresponding to a target source of content through which a subscriber of the social media campaign tracking platform can share the content with third parties via social media. The tracking link has encoded therein structured metadata indicative of a social media action within which the tracking link is contained. Responsive to receiving a click-through event for the tracking link from a requestor, click information is stored in a consumption database associated with the social media campaign tracking platform and the requestor is redirected to the target source.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram conceptually illustrating an exemplary network environment in which embodiments of the present invention may be implemented.

FIG. 2 is a block diagram conceptually illustrating the interactions among various functional units in accordance with one embodiment of the present invention.

FIG. 3 is a block diagram conceptually illustrating the interactions among various functional units in accordance with another embodiment of the present invention.

FIG. 4 conceptually illustrates the automatic creation of unique tracking links for sharing content in the context of different social media services.

FIG. 5A conceptually illustrates the viral spread of content through social media.

FIG. 5B conceptually a link spreading across channels and tools with parent/child relationships involved in accordance with various embodiments of the present invention.

FIG. 5C conceptually illustrates a link spreading across channels and tools with parent/child relationships involved in accordance with various embodiments of the present invention.

FIG. 6 is a simplified, high-level flow diagram illustrating a content sharing process in accordance with an embodiment of the present invention.

FIG. 7 shows in tabular form excerpted redirection metadata in accordance with an embodiment of the present invention.

FIG. 10 is a screen shot of an original_url screen for the links for the blog post of FIG. 5C in accordance with an embodiment of the present invention

FIG. 11 is a screen shot of an awesm_url detail for a parent link in accordance with an embodiment of the present invention.

FIG. 12 is a screen shot of an awesm_url detail for a child link in accordance with an embodiment of the present invention.

FIG. 13 is a screen shot of an example start page in accordance with an embodiment of the present invention.

FIG. 14 is a screen shot of an example details page in accordance with an embodiment of the present invention.

FIG. 15 is a screen shot of an page showing exemplary dimensions in accordance with an embodiment of the present invention.

FIG. 16 is an example of a computer system with which embodiments of the present invention may be utilized.

### DETAILED DESCRIPTION

Methods and systems are described for facilitating a campaign tracking platform for social media marketing. According to one embodiment, an application programming interface (API) is provided that allows publishers and/or professional marketers to create novel tracking links for their content. Each tracking link represents the unique social media action within which it is contained (e.g., a given tweet, Facebook post, email, etc.) and is encoded with structured metadata describing that social media action.

The structured metadata may include, but is not limited to: the channel in which the action exists (e.g., Twitter, Facebook, MySpace, etc.); the tool by which the action was initiated (e.g., Twitterfeed, AddToAny, TweetPo.st, etc.); the unique identifier of the action in the channel (e.g., a status identifier of the tweet in Twitter or a post identifier of the post in Facebook); the time at which the action took place; the cookie and/or user id of the individual who has initiated the action (if present); and the identifier of the parent action (if present).

These metadata may be entered at the time of tracking link creation by a tool with which the tracking link is created. In some embodiments, some or all of the metadata may be added after link creation. For example, a post_id field, which represents the unique identifier of the social media action in its appropriate channel, may be added to a tracking link after link creation because the link is required to make the post, which is in turn required to have a post_id.

As the tracking enabled content is accessed or shared, the campaign tracking platform collects clicks and/or other conversion information per tracking link, and those data can be presented in aggregate or as an average per each dimension or any combination of dimensions, including, but not limited to: campaign; channel; tool; content; sharer; and action. By being able to analyze the data over time along these dimensions, both humans and software can detect patterns of relative effectiveness along dimensions or combinations of dimensions to inform optimization of subsequent efforts.

According to one embodiment, information regarding parent-child relationships within tracking links can be used to map the spread of viral content. Social media is a “viral” medium in which a given action can directly cause subsequent actions. For example: if one were to share a piece of content with their friends on Facebook, this might drive some of them to view it and some of that group to share it with others. Mapping the causal relationships between these social media actions (i.e., the shares) is valuable to both understanding the holistic real impact of a given upstream action as well as illustrating the flow of word of mouth through social groups.

In one embodiment, the campaign tracking platform generates a unique tracking link that represents the social media action within which it is contained. As discussed further below, the campaign tracking platform also allows for parent/child relationships between these links for the purpose of connecting related actions and mapping the causal relationships between the related actions. Building the parent/child relationships involves connecting the parent action to the child action, which may be done, for example, by enabling customers to have a parameter appended to the destination URL of redirect tracking links for content hosted on pages on which the publisher has a tracking-enabled sharing tool (e.g., AddToAny share widget, Sociable WordPress plugin, fbShare.me button and the like). According to one embodiment, code embodied within the destination page reads the parameter from the URL location and passes it to the campaign tracking platform when a new social media action is initiated.

In various embodiments, the parent/child relationships are uni-directional (i.e., only the child link contains the notion of its parent), and thus can scale ad infinitum through generations or across siblings within a given generation. These parent/child relationships allow the campaign tracking platform to attribute downstream shares, clicks, and conversions from descendant links to any of their ancestors as well as to present visual representations of the relationships (e.g., family trees).

In general, the campaign tracking platform in accordance with various embodiments of the present invention seeks to provide (i) an end-to-end view of the effectiveness of social media marketing efforts and (ii) actionable analytics and data-driven optimization that can measurably improve the ROI of social media marketing efforts.

Importantly, although various embodiments of a campaign tracking platform are discussed as if the service were implemented at a centralized web location, it is contemplated that such a platform may be centralized or distributed.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

### Terminology

Brief definitions of terms used throughout this application are given below.

The terms “connected” or “coupled” and related terms are used in an operational sense and are not necessarily limited to a direct connection or coupling.

The phrase “create type” and the parameter “create_type” generally refer to from where the target is being shared. In the context of passing a create_type parameter to an API associated with the campaign tracking platform, the create_type parameter represents the method by which the share was initiated.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “parent” generally refers to why the target is being shared. In the context of passing a parent parameter to an API associated with the campaign tracking platform, the parent parameter is used to establish parent/child relationships between links for attributing secondary traffic in connection with reporting performed by the campaign tracking platform. If the user arrived at the current page through a redirect URL generated by the campaign tracking platform, then the parent parameter is the id of the link they followed to get to the current page.

The term “responsive” includes completely or partially responsive.

The term “share” generally refers to any action that pushes a link out to an intended recipient or audience. According to this definition, posting a link to a Facebook profile, sending it through instant messaging (IM), including it in a marketing mass email and/or promoting it through an ad are all considered “shares” of the link. At the core of embodiments of the campaign tracking platform is its ability to instrument uniform resource locators (URLs) with structured metadata about “shares.” In various embodiments of the present invention, the campaign tracking platform provides an extensible framework for encoding the share metadata across multiple outbound channels to give the publisher a cohesive picture and better understanding of all his/her share-driven traffic. Notably, in embodiments of the present invention, there can be many shares for a given destination page, and each one has unique metadata—the who, what, when, where, whey and how of a share. In such embodiments, the campaign tracking platform encodes the metadata in a manner that allows the shares to be compared against one another after the fact and captures traffic data for each individual share. In this manner, the campaign tracking platform adds value by being connected to the context of the share (e.g., post this link to Twitter) and facilitates tracking and reporting regarding multiple channels in a systematic and integrated fashion. For example, by using tracking links, the publisher has the ability to group all shares for a given destination page by their “hows” (i.e., share type) and compare the relative performance based on total clicks per channel, or the publisher could just as easily group and compare that same data by the “whos” (i.e., sharer id).

The phrase “share type” and the parameter “share_type” generally refer to how the target is being shared. In the context of passing a share_type parameter to an API associated with the campaign tracking platform, the share_type parameter represents the channel for which the target is destined. Typically, a publisher will create a unique URL for each channel through which the publisher wishes to share the target page link.

The phrase “sharer_id” and the parameter “sharer_id” generally refer to who is sharing the target. In the context of passing a sharer_id parameter to an API associated with the campaign tracking platform, the sharer_id parameter uniquely identifies the user who initiated the share. In one embodiment, the sharer_id may be a globally unique identifier (GUID). In order to give publishers the most useful and actionable data, the campaign tracking platform builds global sharer and clicker profiles using a sharer id stored in a cookie, for example, when a user shares or clicks a tracking link. The sharer id can be captured in use-cases that involve end-users initiating shares associated with a publisher's share widget embedded on their site.

The term “target” generally refers to what is being shared. In the context of passing a target parameter to an API associated with the campaign tracking platform, the target represents a URL of the destination page that is intended to be shared and for which a corresponding tracking link is desired.

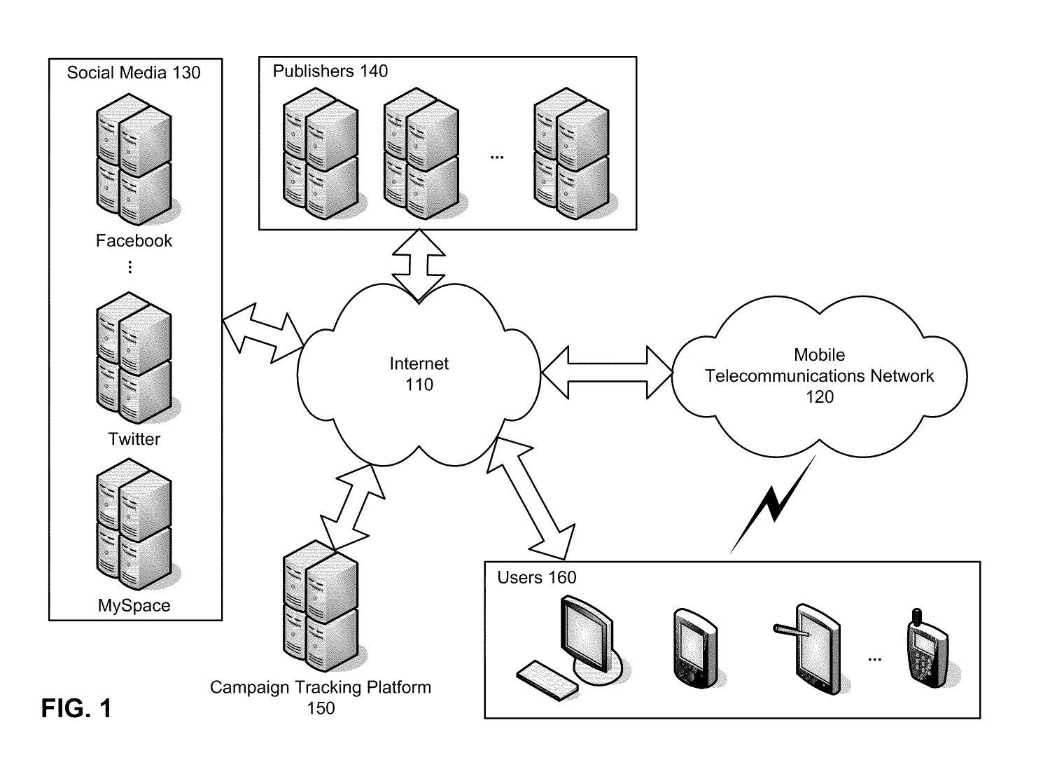

FIG. 1 is a block diagram conceptually illustrating an exemplary network environment in which embodiments of the present invention may be implemented. According to the present example, a public communication network, such as the Internet 110, interconnects social media 130, publishers (including advertisers and marketers) 140, a campaign tracking platform and users 160. Mobile users making use of smart phones (e.g., a BLACKBERRY smartphone device, an IPHONE Internet- and multimedia-enabled smartphone and the like), personal digital assistants and other mobile Internet-enabled devices, such as laptops with USB modems or connected via GPRS-enabled mobile phones, may access Internet resources via a mobile telecommunications network 120, which may implement various specifications of the International Telecommunication Union, including, but not limited to 2G, 2.5G, 3G (International Mobile Telecommunications-200 (IMT-2000), GSM EDGE and the like.

Publishers 140 typically include (i) companies desiring to make consumers aware of their products, services, brands and/or the advantages thereof to increase consumption or (ii) organizations (e.g., political parties, interest groups, religious organizations and governmental agencies). Publishers 140 can also include (a) content providers including, but are not limited to, organizations or individuals that create news, information, educational or entertainment content that is accessible via the Internet (b) individuals and (c) professional marketing and/or advertising agencies that create and/or place/distribute advertising on behalf of companies or organizations. Examples of content providers include magazine-like entities, such as Hot Wired, newspaper websites, such as the New York Times online, portals, blogs, online gaming sites and YouTube.

Social media 130 includes companies or services that facilitate the creation and/or delivery of media designed to or having the effect of being disseminated through social interaction. As such, social media 130 includes, but is not limited to existing companies and services, such as Twitter, Facebook, MySpace and the like, Internet forums, blogs, wikis, podcasts and the like, as well as future variations thereof.

According to one embodiment, campaign tracking platform 150 provides tools for professional marketers and publishers to more efficiently and productively use and measure the effectiveness of social media as an online marketing channel. As described further below, the campaign tracking platform 150 may interact with both publishers 140 and social media 130 by providing tracking links to publishers that can be posted to social media 130 and thereafter collecting information regarding shares, clicks and other conversions.

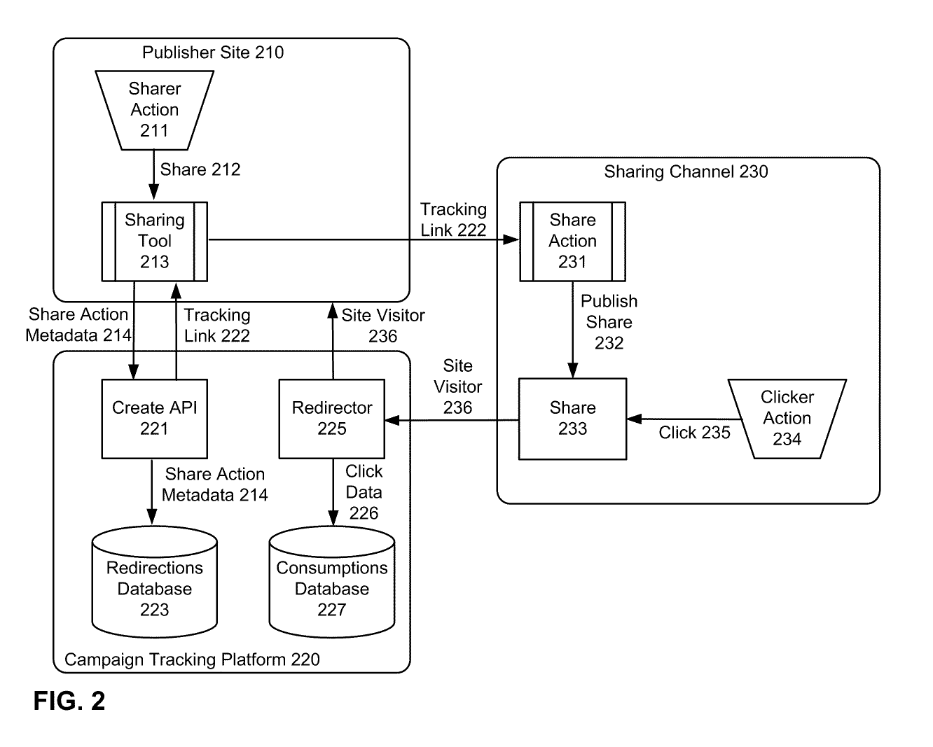

FIG. 2 is a block diagram conceptually illustrating the interactions among various functional units in accordance with one embodiment of the present invention. According to the present example, various interactions among a publisher site 210, a campaign tracking platform 220 and a sharing channel 230 (e.g., Twitter, Facebook, MySpace, etc.) are illustrated.

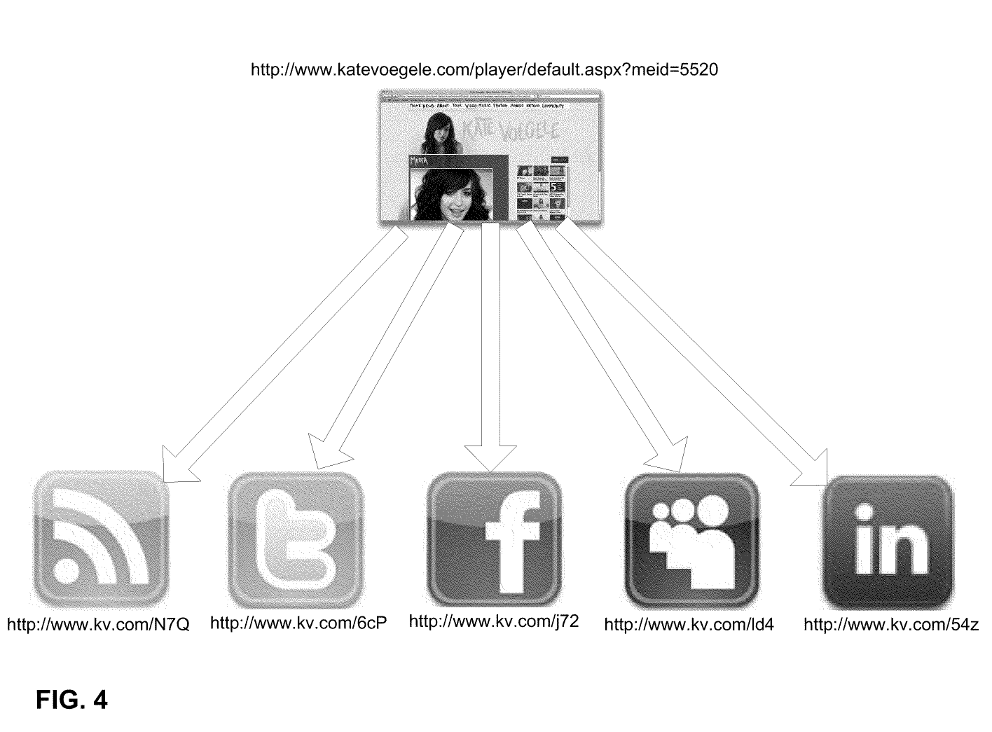

Starting at the publisher site 210, responsive to an end-user initiating a sharer action 211 (e.g., request to share content) via a sharing tool 213 (a third-party publisher system), the sharing tool 213 sends a request to a create API 221 of the campaign tracking platform. The request contains or is otherwise associated with share action metadata 214, which represents metadata about a desired link to be shared, including the destination URL of the content to be shared. For example, with reference to FIG. 4, a user interacting with the Kate Voegele website or someone otherwise affiliated with the site may share content associated with the site via one or more of RSS, Twitter, Facebook, MySpace and LinkedIn.

The create API 221 stores the share action metadata 214 in a database, e.g., redirections database 223 and generates a tracking link 222 corresponding to the desired link that points to the campaign tracking platform 220 or a location otherwise associated with or under common control with the campaign tracking platform 220 and redirects to the desired link. The tracking link 222 is a unique URL, typically in shortened form, which is returned to the sharing tool 213. Notably, with reference to FIG. 4, in one embodiment, each channel in which a share is created receives a unique tracking link.

The sharing tool 213 passes the tracking link 222 as part of the user's content to systems of a third-party within the sharing channel 230 via a share action 231 (e.g., an API associated with the third-party system). The sharing channel 230 then publishes the content (publish share 232), including the tracking link 222, as part of their own operations to produce a share 233 (e.g., a tweet, Facebook post, etc.).

Users of the sharing channel 230 can then interact with the share 233, including (i) clicking or otherwise selecting the tracking link 222 embedded within the share 233 or (ii) themselves creating a child share (not shown) by commenting on the share 233 or otherwise republishing the tracking link 222 and potentially some subset of the content. In the case of the former, the user becomes a site visitor 236 and the user's request is first directed to a redirector 225 of the campaign tracking platform 220. The redirector 225 looks up the share action metadata 214 associated with the tracking link 222 in the redirections database 223 and uses the destination URL to instruct the site visitor's browser to automatically be redirected to the shared content on the publisher site 210. The redirector 225 generates click data 226 to be stored in a consumptions database 227 of the campaign tracking platform 220 based on the retrieved share action metadata 214 and data about the site visitor 236, including, but not limited to the time of click, the Internet Protocol (IP) address of the site visitor 236, and information about the browser software (“user-agent string”) that is being used by the site visitor 236.

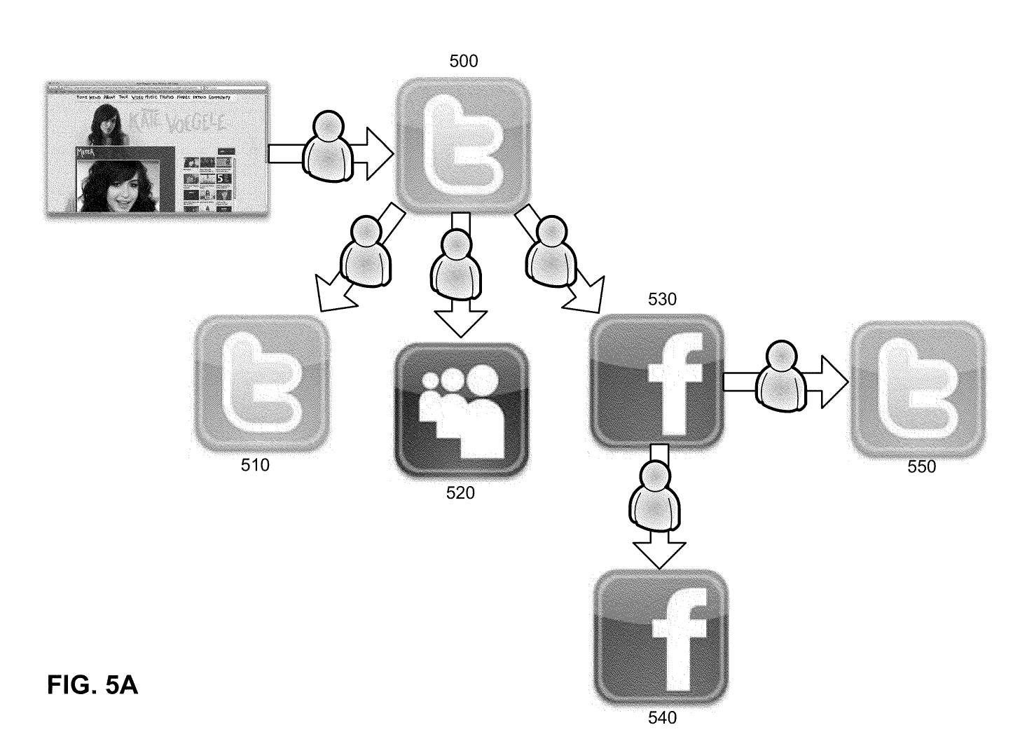

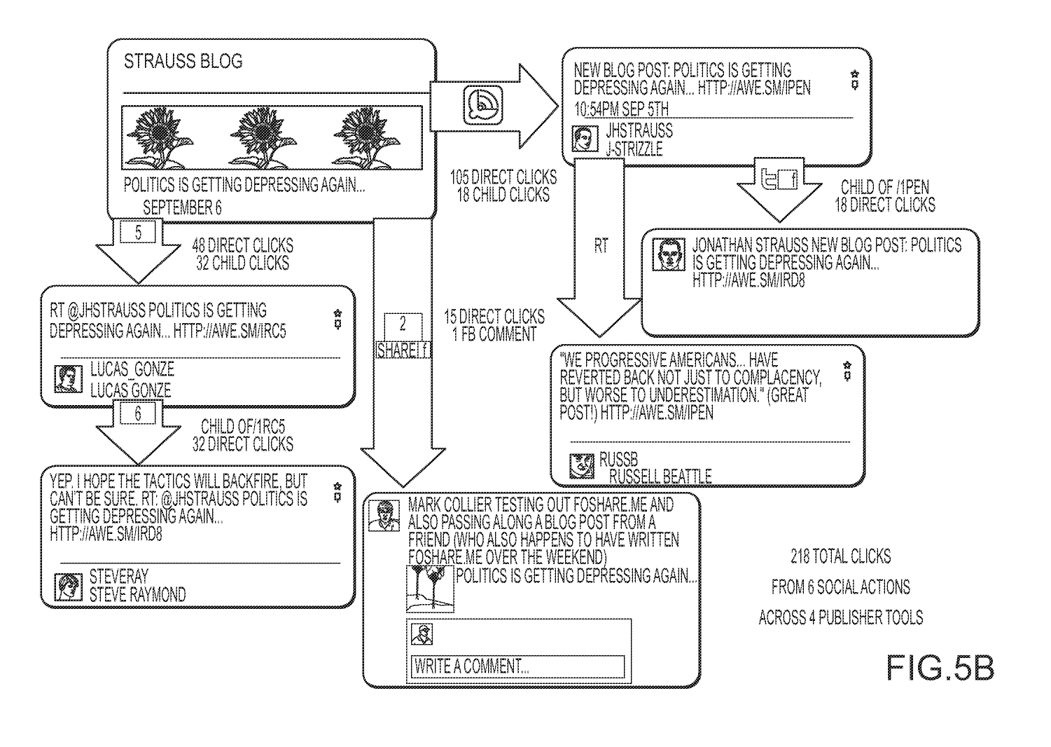

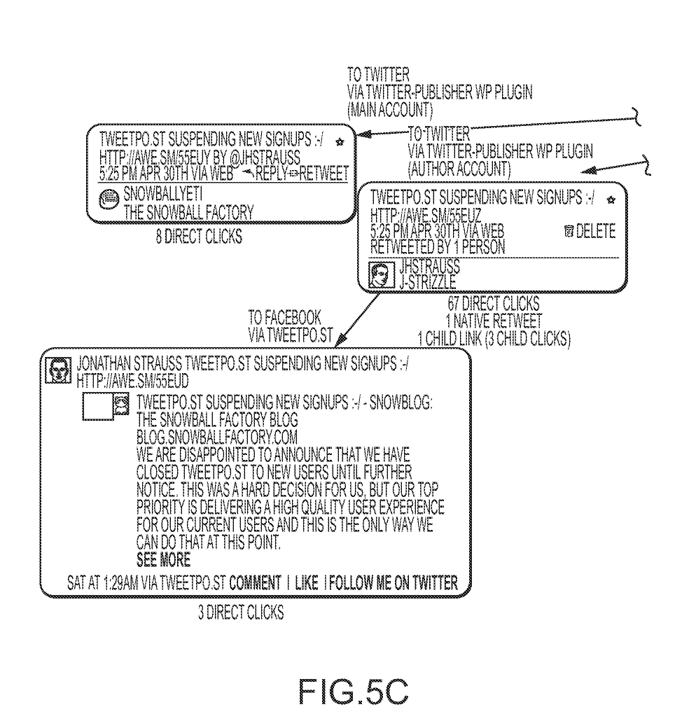

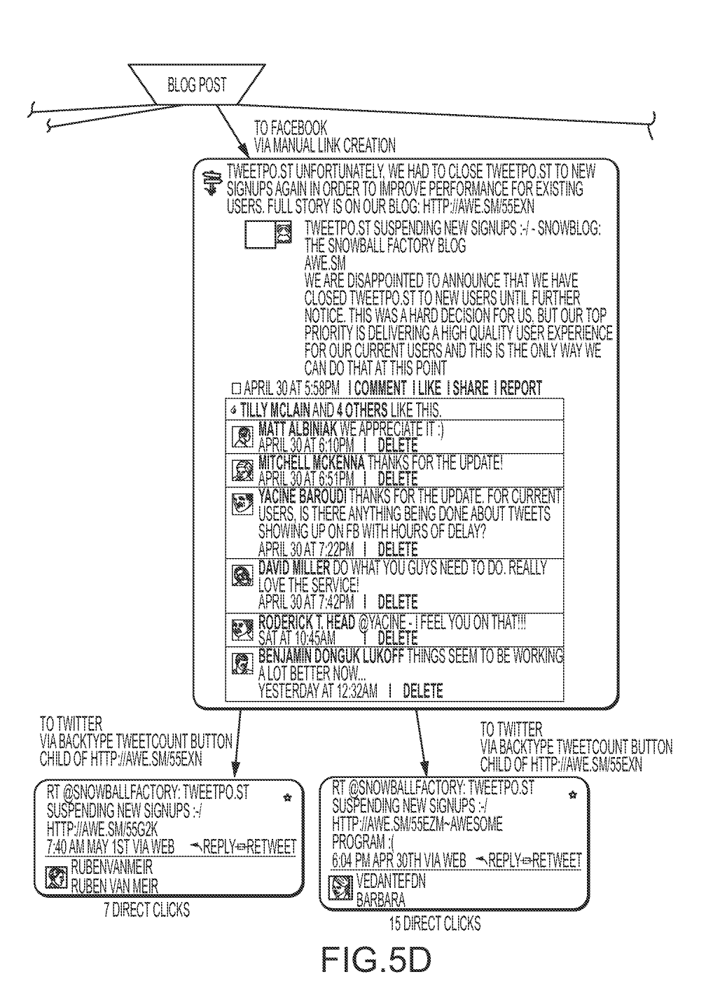

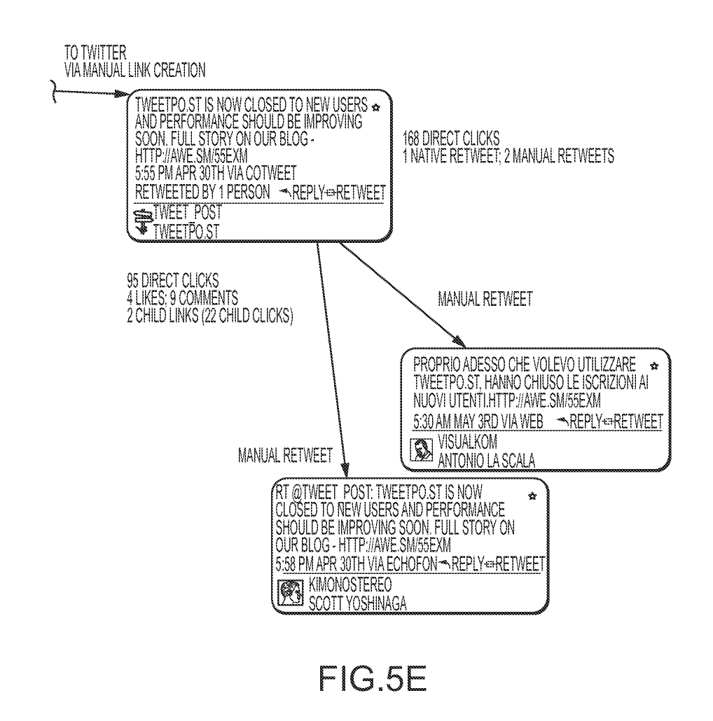

In the latter case, in which the end user interacting with the share 233 creates a child share (not shown), the third-party system with which the share 233 is currently associated essentially becomes a publisher in the context of FIG. 2 and a new tracking link can be generated by a sharing tool associated with the third-party system. For example, with reference to FIG. 5, note that an original share 500, a parent share, (e.g., a tweet containing a tracking link) can be shared by others to create child shares 510, 520 and 530 and such child shares can also be further shared and so on.

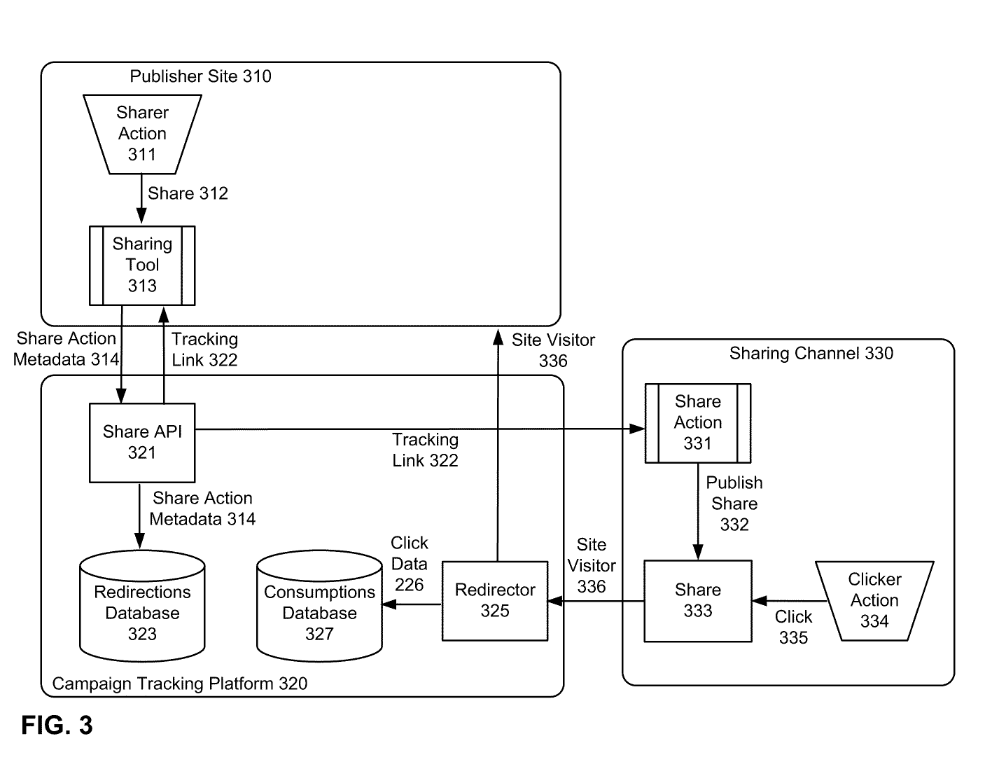

FIG. 3 is a block diagram conceptually illustrating the interactions among various functional units in accordance with another embodiment of the present invention. In this example, a tracking link 322 is created by a share API 321 of a campaign tracking platform 320. The flow for usage of the share API 321 is substantially the same as that described above for the create API 221, with the exception that after the tracking link 322 is created, instead of relying on the publisher's sharing tool 313 to inject the content into the sharing channel 330, the share API 321 does so directly. Notably, the embodiments depicted by FIG. 2 and FIG. 3 need not be different embodiments. For example, a campaign tracking platform 150, 220 and 320 may include an API having both a create interface and a share interface as well as other interfaces for reporting as described in the Appendix of the U.S. Provisional Patent Application No. 61/331,380, which is incorporated herein by reference.

While in the block diagrams of FIG. 2 and FIG. 3, the various APIs, modules and other functional units may appear to be described as residing within or as part of a single server, in alternative embodiments one or more of these functional units may be implemented within separate, interacting servers. For example one or more highly-reliable servers of or associated with the campaign tracking platform 150, 220 and 320 may be dedicated to processing requests and performing load balancing among other redirection servers where the redirector functionality may be performed. Various other configurations and architectures will be appreciated by those skilled in the art based on scalability needs, the need for real-time response and similar considerations.

In various embodiments, the functionality of one or more of the above-referenced functional units/modules may be merged in various combinations. For example, the data in the redirections database 323 and the consumptions database 327 may be combined or distributed differently. Similarly, the campaign tracking platform functionality may be integrated within the publisher site, thereby combining the sharing tool functionality with the create API functionality and/or the share API functionality. Moreover, the various functional units/modules can be communicatively coupled using any suitable communication method (e.g., message passing, parameter passing, and/or signals through one or more communication paths, etc.). Additionally, the functional units/modules described herein can be physically connected according to any suitable interconnection architecture (e.g., fully connected, hypercube, etc.).

According to embodiments of the invention, the functional units/modules can be any suitable type of logic (e.g., digital logic, software code and the like) for executing the operations described herein. Any of the functional units/modules used in conjunction with embodiments of the invention can include machine-readable storage media including having tangibly embodied therein instructions for performing operations described herein. Machine-readable storage media include any mechanism that stores information in a form readable by a machine (e.g., a computer). For example, a machine-readable medium includes, but is not limited to, read only memory (ROM), random access memory (RAM), magnetic disk storage media, optical storage media or flash memory devices.

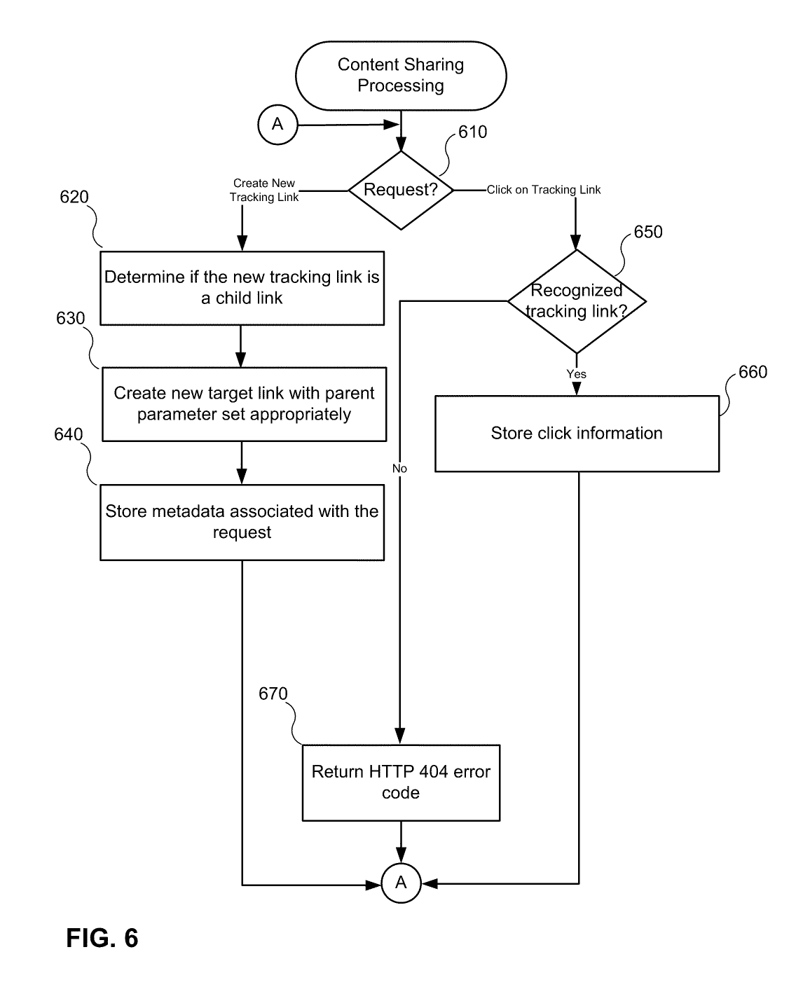

FIG. 6 is a simplified, high-level flow diagram illustrating a content sharing process in accordance with an embodiment of the present invention from the perspective of the campaign tracking platform. According to the present example, the content sharing process begins at decision block 610 where requests are processed. For simplicity only two types of requests are discussed with reference to FIG. 6, requests from sharing tools to create new tracking links and requests representing selection of an existing tracking link.

According to one embodiment, when a sharing tool makes an HTTP request to one of the servers associated with the campaign tracking platform, prior to decision block 610, the sharing tool is authenticated by a unique key (a long sequence of pseudo-random characters) which also identifies the account associated with the request. Details regarding an exemplary request are described in the Appendix of the U.S. Provisional Patent Application No. 61/331,380, which is incorporated herein by reference.

Returning to decision block 610, requests are processing by determining the type of request. If the request is to create new tracking link, then processing continues with block 620; otherwise if the request represents a click on a tracking link, then processing continues with decision block 650. According to one embodiment, one or more highly-reliable servers (e.g., HAProxy of FIG. 8) initially handle the requests. Requests that look like tracking links based on an inspection of the URL at issue are sent to a redirection server (e.g., one of the eight redirectors shown in FIG. 8). Depending upon the implementation, those skilled in the art will recognize that more or fewer redirection servers may be employed.

At block 620, the request has been determined to be a request to create a new tracking link and a determination is made with regard to whether the new tracking link is a child link. According to one embodiment and as described in the Appendix of the U.S. Provisional Patent Application No. 61/331,380, which is incorporated herein by reference, as part of the request to create the tracking link, the sharing tool can provide a parent (“parent awesm”) parameter. If this parameter is set, then the redirections database is queried for an existing redirection matching the description. If it exists, the new tracking link (redirection) can be created in block 630 with the parent parameter set to the given value (child links “know” who their parent is).

In some embodiments, even if the parent parameter is not set, an inspection of the destination URL supplied (URL A) may be performed to determine if the domain is one that is currently being tracked by the campaign tracking platform. If the domain is one currently being tracked, then it is assumed this request relates to one of the campaign tracking platform's own tracking links being re-shared, and the destination URL is treated as if it were the “parent awesm” parameter. In this case, the new tracking link is created at block 630 with its parent as URL A, and its destination URL is set to the original destination URL of A.

According to one embodiment, the new tracking link is generated by concatenating a domain (e.g., the publisher's own domain or other) and a short sequence of characters, guaranteed unique for that domain. In the Appendix of the U.S. Provisional Patent Application No. 61/331,380, which is incorporated herein by reference, this short sequence of characters is referred to as a “stub”.

At block 640, the metadata associated with the request from the share tool is stored. Details regarding exemplary metadata are provided in the Appendix of the U.S. Provisional Patent Application No. 61/331,380, which is incorporated herein by reference. According to one embodiment, the request information and/or the metadata associated therewith is stored in a database (e.g., MySQL database of FIG. 8). At this point, processing relating to creating a new tracking link is complete and processing returns to decision block 610 to process subsequent requests.

At decision block 650, it is determined if the tracking link is recognized as valid by a redirection server. If not, the user is shown a 404 error page at block 670. If it is a valid tracking link, the redirection server redirects the browser to the shared content (original_url or “target” of the tracking link) and then stores the click information in the consumptions database (block 660). In some embodiments, tracking link selection processing is performed by multiple redirection servers and a determination is made based to which of the multiple redirection servers the request should be directed based on the relative loads of the multiple redirection service.

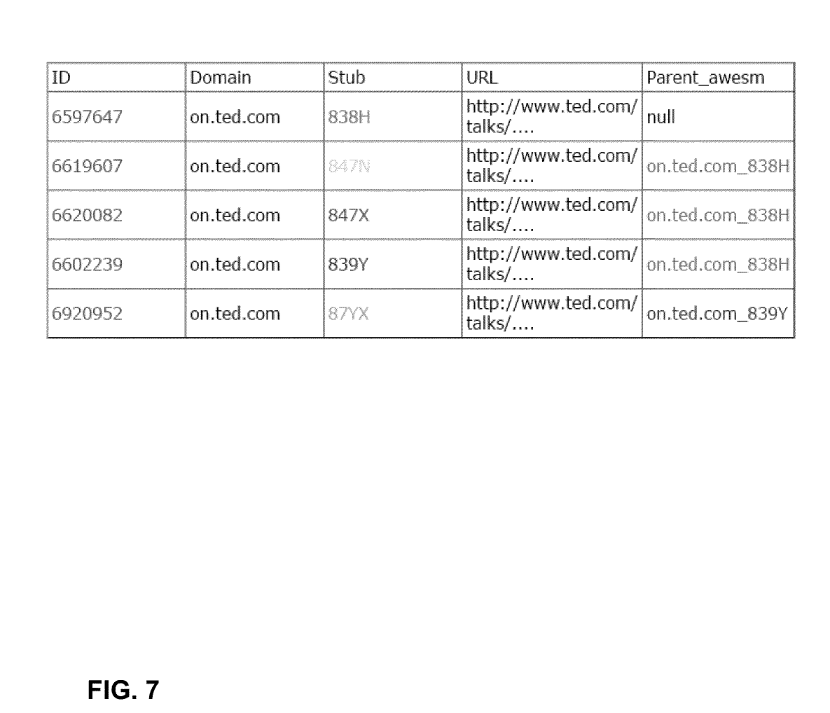

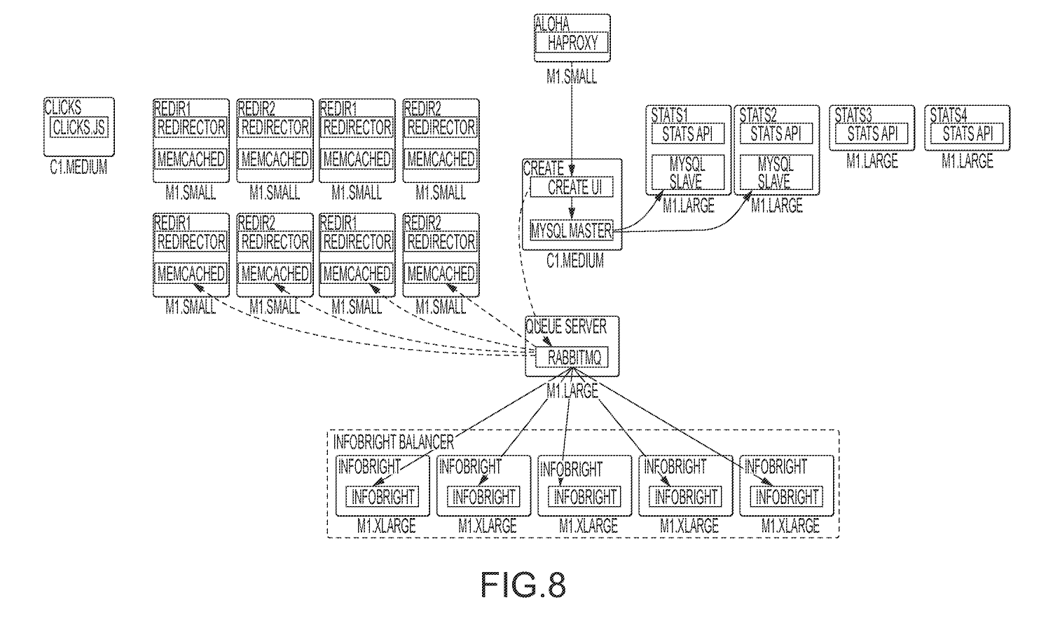

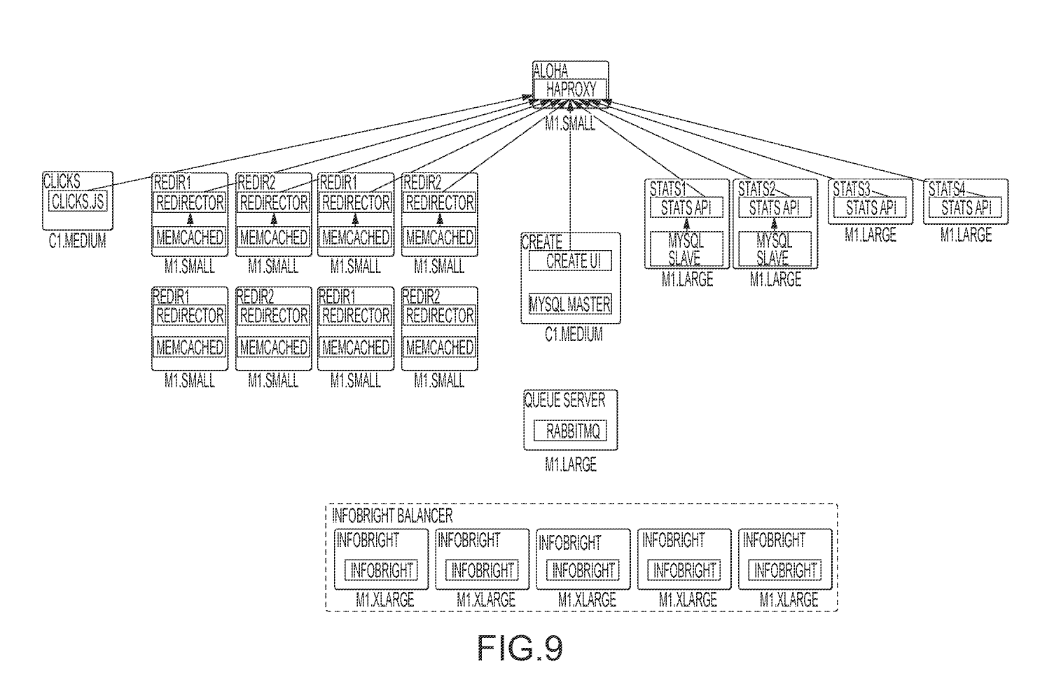

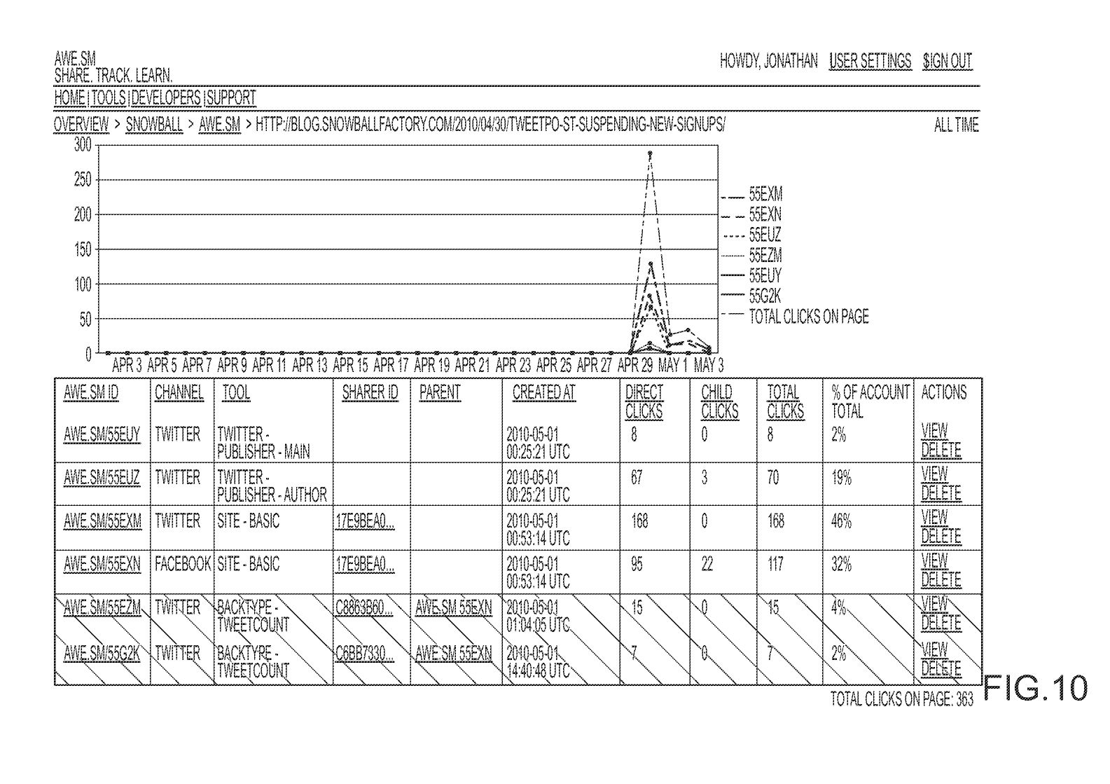

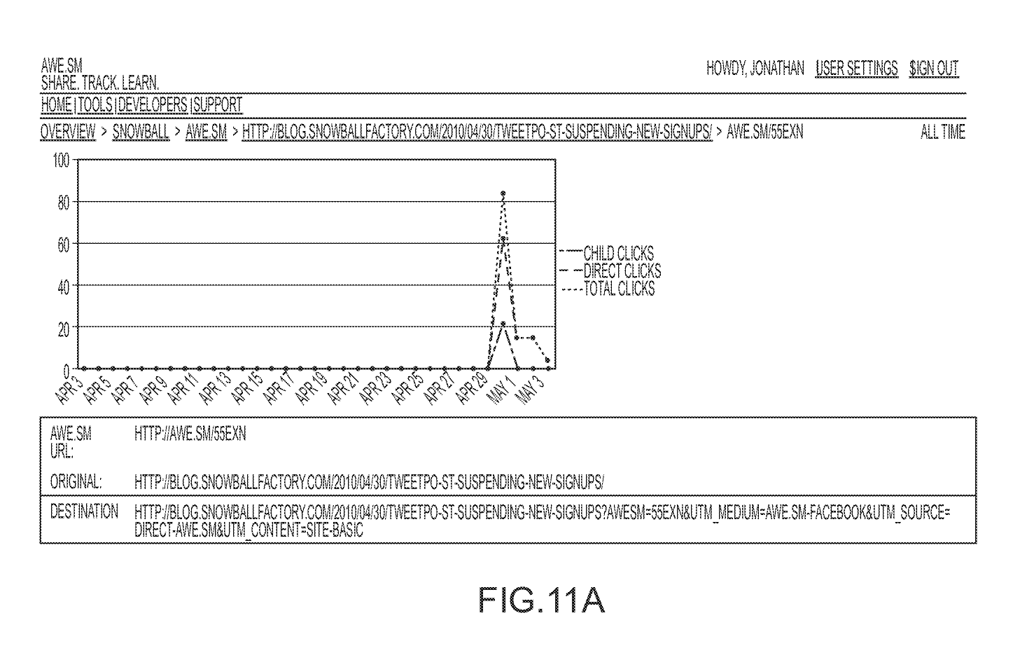

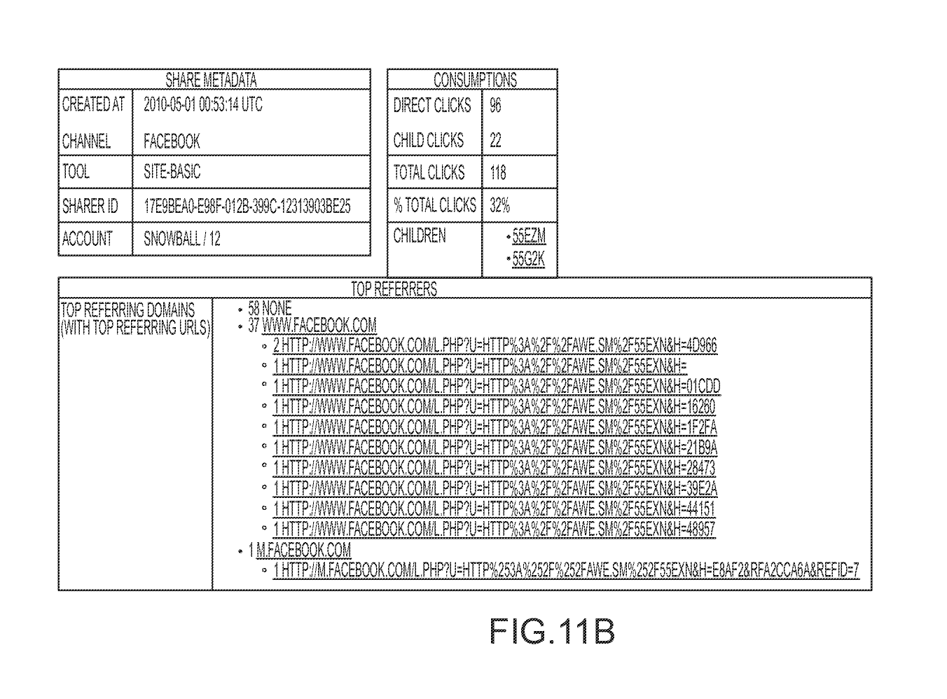

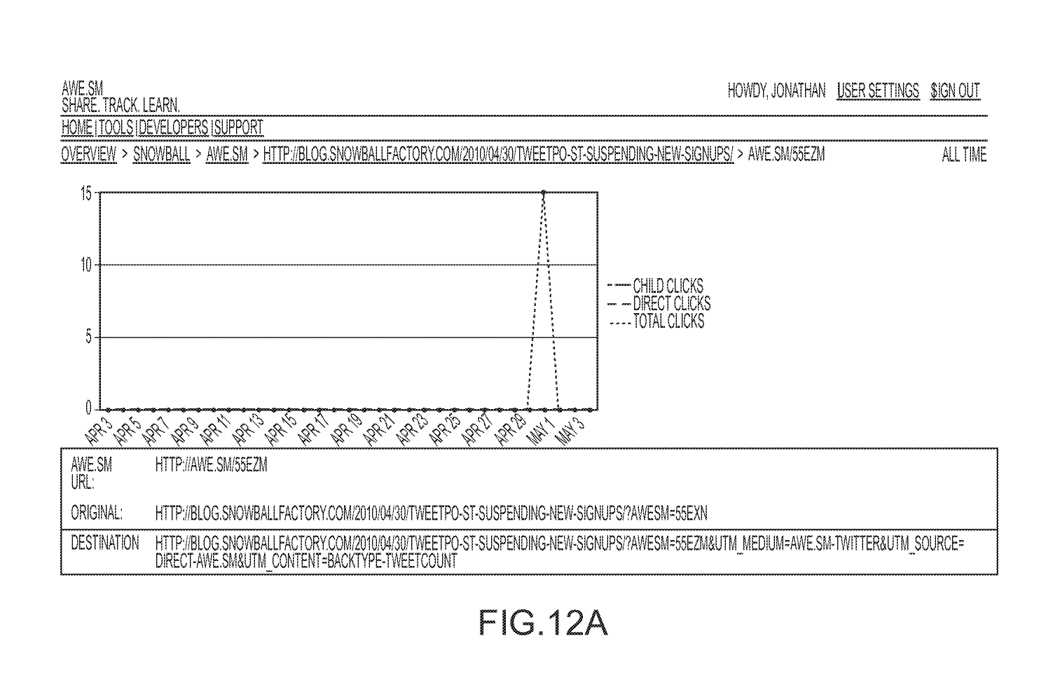

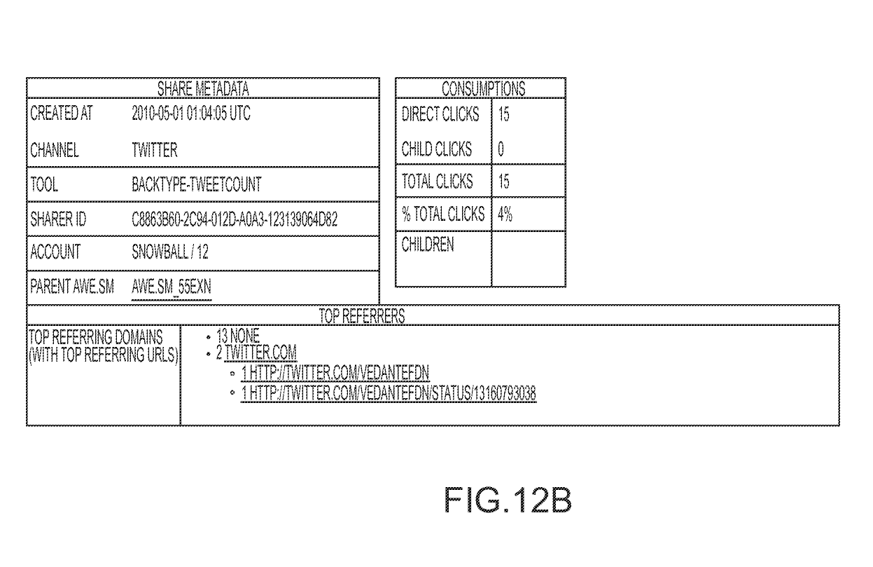

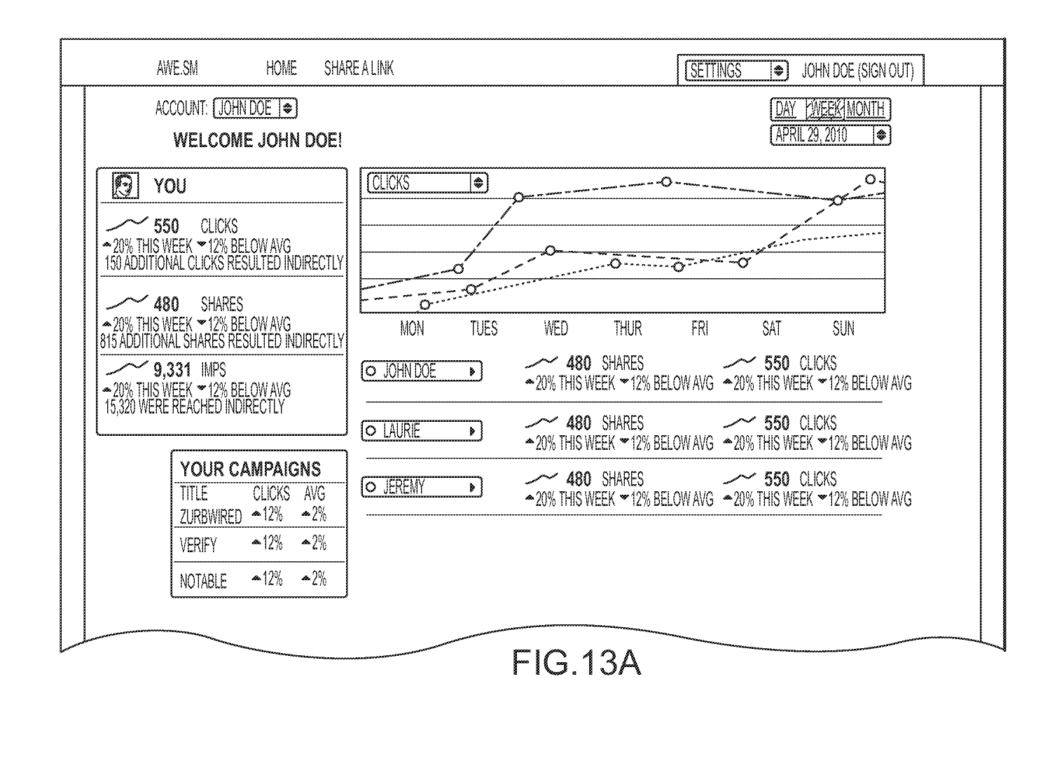

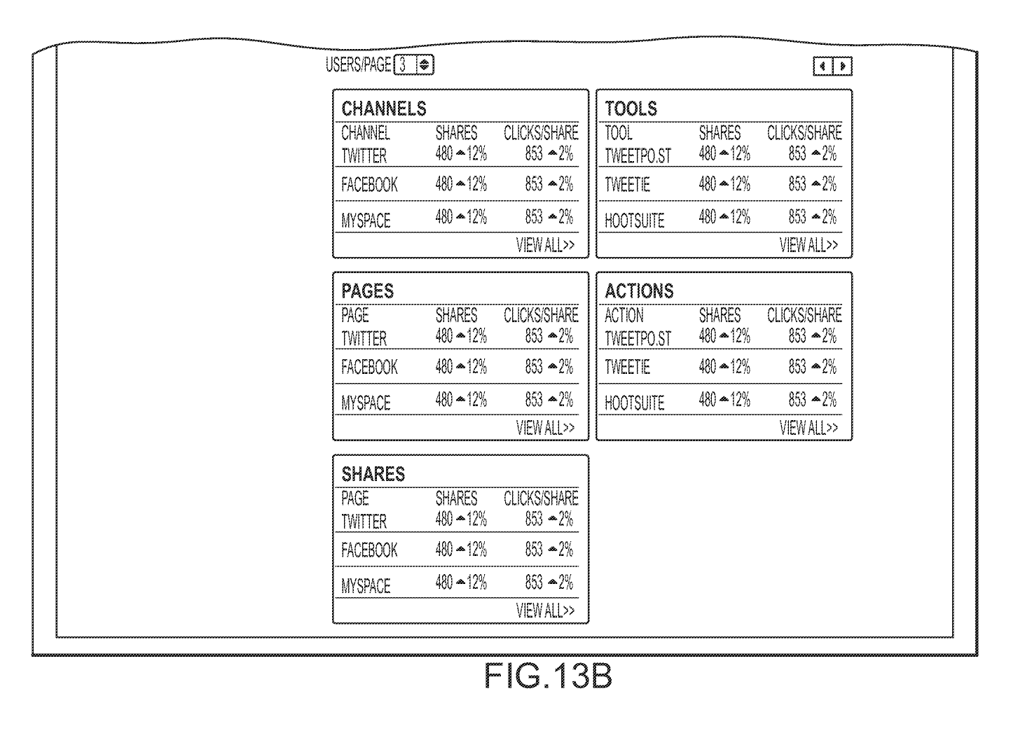

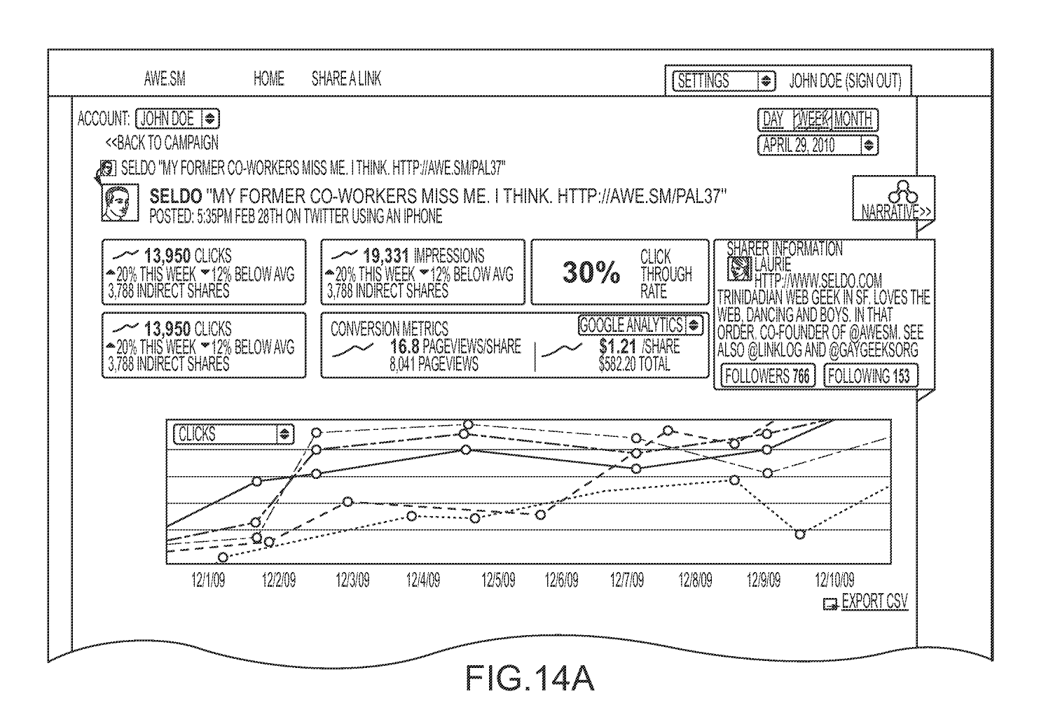

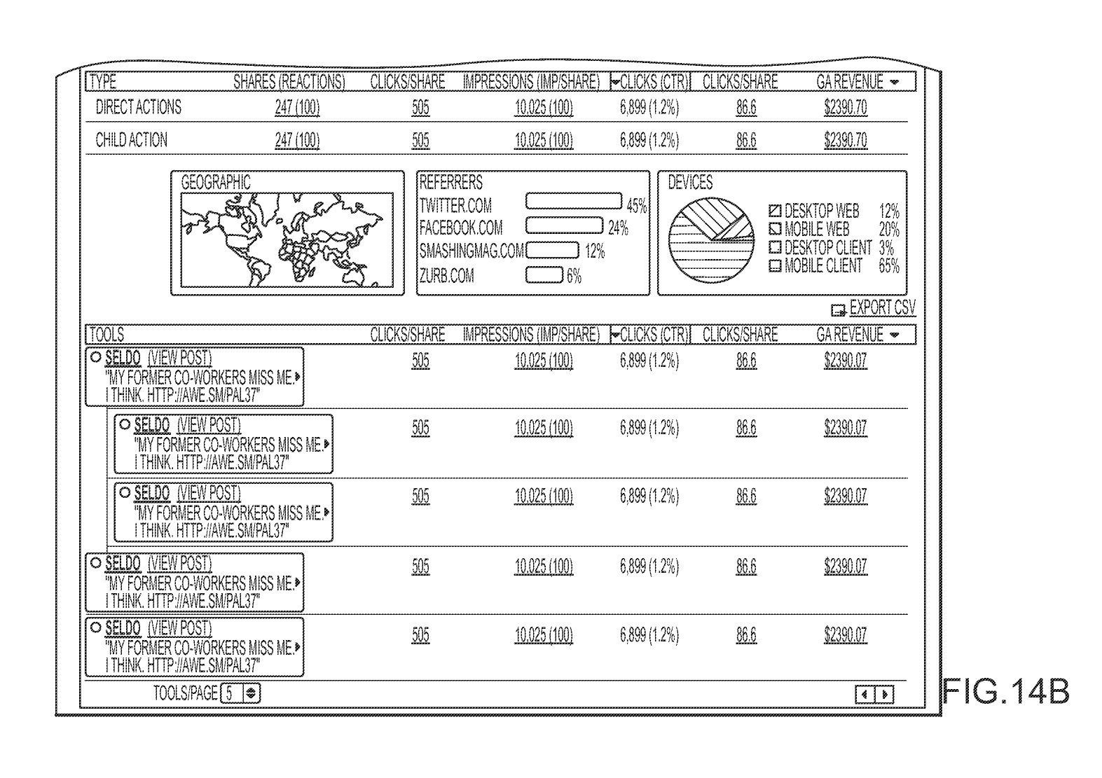

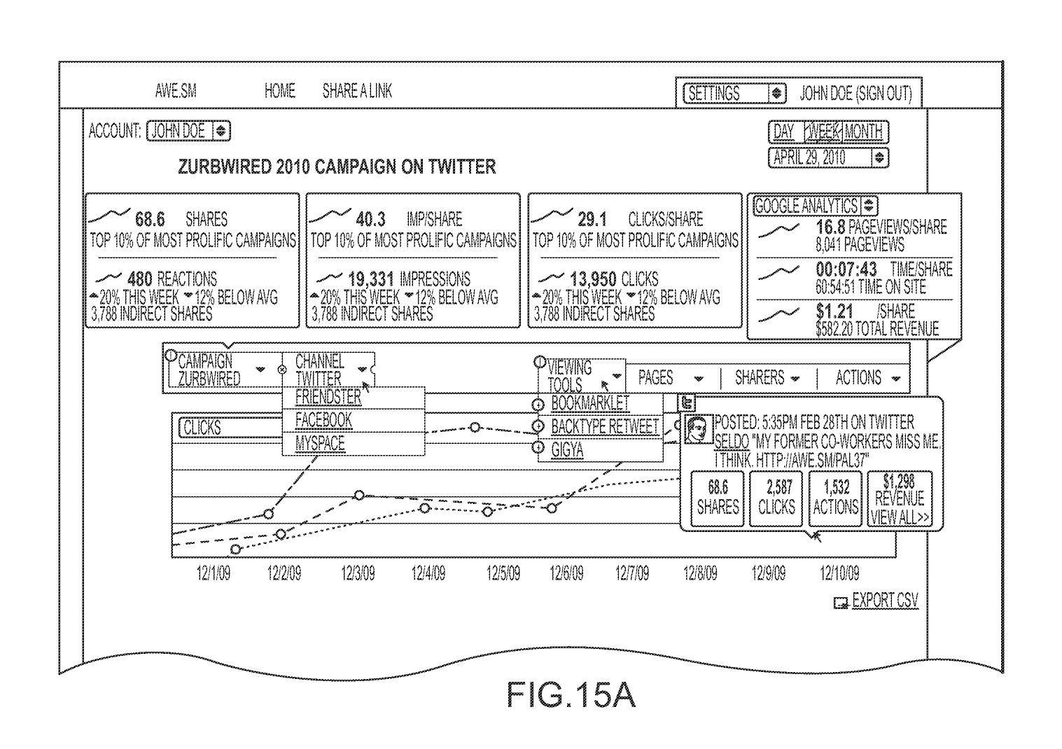

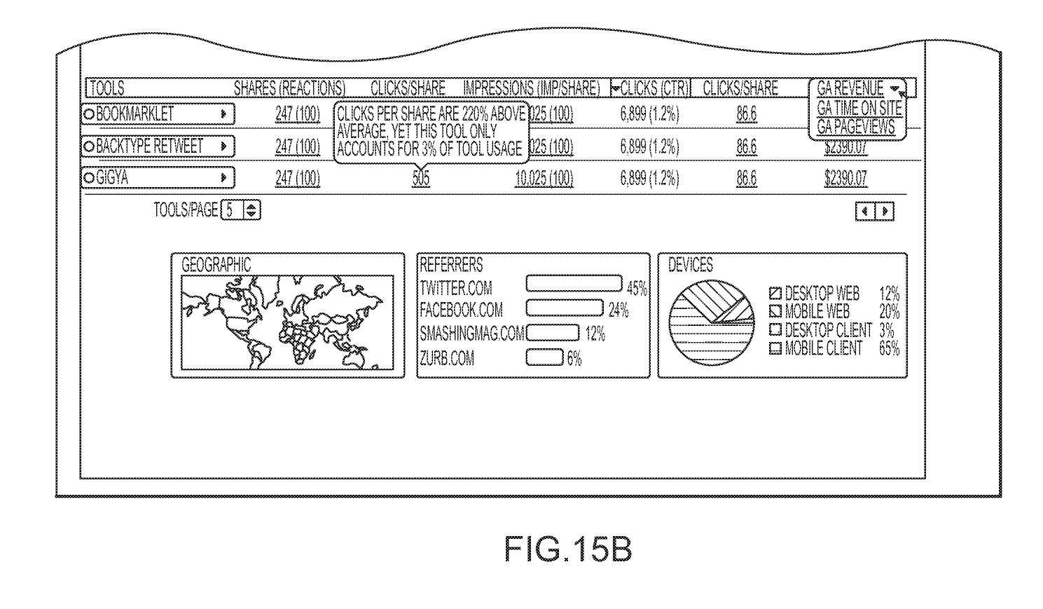

FIG. 7 shows in tabular form excerpted redirection metadata in accordance with an embodiment of the present invention. According to this example, a simplified view of a subset of typical redirection metadata is shown for purposes of explaining how children links are identified.

In the current example, the first row is a parent, so it has an empty (null) parent_awesm value. The stub in red (838H) has 3 children, including the blue stub (839Y), which has one child of its own (87YX).

To find all the children of link 6597647, all links with a parent_awesm of “on.ted.com_{—}838H”, the combination of its domain and stub, are identified. Children of those children can in turn be found, until a list of all the IDs associated with this tree is found. Information regarding the clicks in the tree can then be aggregated by fetching counts for all the IDs in a tree and combining same.

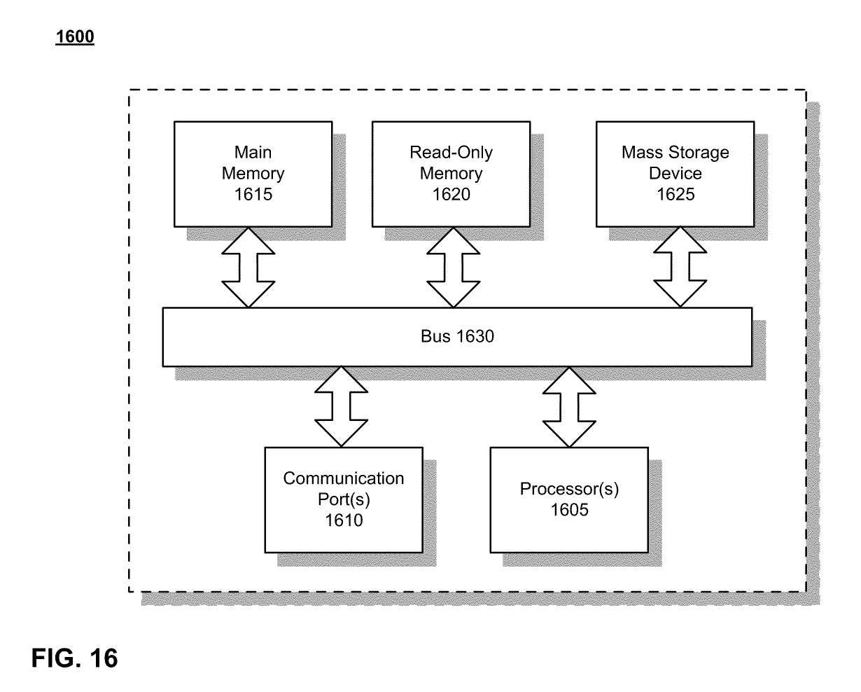

FIG. 16 is an example of a computer system with which embodiments of the present invention may be utilized. Embodiments of the present invention include various steps, which have been described above and which are also described in the Appendix of the U.S. Provisional Patent Application No. 61/331,380, which is incorporated herein by reference. A variety of these steps may be performed by hardware components or may be tangibly embodied on a computer-readable medium in the form of machine-executable instructions, which may be used to cause a general-purpose or special-purpose processor programmed with instructions to perform these steps. Alternatively, the steps may be performed by a combination of hardware, software, and/or firmware. As such, FIG. 16 is an example of a computer system 1600, such as a server (e.g., HAProxy, queue server and/or redirect server of FIGS. 8 and 9), upon which or with which embodiments of the present invention may be employed.

According to the present example, the computer system includes a bus 1630, one or more processors 1605, one or more communication ports 1610, a main memory 1615, a removable storage media 1640, a read only memory 1620 and a mass storage 1625.

Processor(s) 1605 can be any future or existing processor, including, but not limited to, an Intel® Itanium® or Itanium 2 processor(s), or AMD®, Opteron® or Athlon MP® processor(s), or Motorola® lines of processors. Communication port(s) 1610 can be any of an RS-232 port for use with a modem based dialup connection, a 10/100 Ethernet port, a Gigabit port using copper or fiber or other existing or future ports. Communication port(s) 1610 may be chosen depending on a network, such a Local Area Network (LAN), Wide Area Network (WAN), or any network to which the computer system 1600 connects.

Main memory 1615 can be Random Access Memory (RAM), or any other dynamic storage device(s) commonly known in the art. Read only memory 1620 can be any static storage device(s) such as Programmable Read Only Memory (PROM) chips for storing static information such as start-up or BIOS instructions for processor 1605.

Mass storage 1625 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 1630 communicatively couples processor(s) 1605 with the other memory, storage and communication blocks. Bus 1630 can include a bus, such as a Peripheral Component Interconnect (PCI)/PCI Extended (PCI-X), Small Computer System Interface (SCSI), USB or the like, for connecting expansion cards, drives and other subsystems as well as other buses, such a front side bus (FSB), which connects the processor(s) 1605 to system memory.

Optionally, operator and administrative interfaces, such as a display, keyboard, and a cursor control device, may also be coupled to bus 1630 to support direct operator interaction with computer system 1600. Other operator and administrative interfaces can be provided through network connections connected through communication ports 1610.

Removable storage media 1640 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the invention.

What is claimed is:

1. A computer-implemented method comprising:
generating, by one or more routines running on one or more computer systems of a social media campaign tracking platform, a tracking link corresponding to a target source of content through which a subscriber of the social media campaign tracking platform can share the content with third parties via social media, wherein the tracking link has encoded therein structured metadata indicative of a social media action within which the tracking link is contained; and
responsive to receiving a click-through event for the tracking link from a requestor, storing click information in a consumption database associated with the social media campaign tracking platform and redirecting the requestor, by a web server running on the one or more computer systems, to the target source.
